(19) United States
(12) Patent Application Publication
(10) Pub. No.: US 2015/0273508 A1
(43) Pub. Date: Oct. 1, 2015

(54) BRUSH SHOWER SPRAY NOZZLE ASSEMBLY

(71) Applicants: Stuart MORGAN, Moorabbin (AU); Sean Morgan, Moorabbin (AU)

(72) Inventors: Stuart MORGAN, Moorabbin (AU); Sean Morgan, Moorabbin (AU)

(21) Appl. No.: 14/226,876

(22) Filed: Mar. 27, 2014

(51) Int. Cl. B05B 15/06; B05B 1/00

(52) U.S. Cl. CPC B05B 15/065; B05B 1/00

(57) ABSTRACT

A brush shower spray nozzle assembly-comprising a metallic spray nozzle 10 having a nozzle body for fixment in a bore of a brush shower 29, a nozzle orifice 15, and a counterbore 16 for retaining an insert 21; the insert 21 for controlling spray through the nozzle orifice 15 in the brush shower 29, the insert 21 having a central aperture 15a; an insert shield 60 having a central shield aperture 65 coaxial with a central insert aperture 15a and tapered in thickness from its periphery 61 toward the central shield aperture 65 for allowing brush 22 access to an area 19 proximal to the central insert aperture 15a.

### CROSS-REFERENCE TO RELATED PATENT APPLICATION

This is a continuation-in-part of application Ser. No. 12/301,237 (Pub. No. US 2009/0266922 A1) being a National Phase application of PCT Application No. PCT/AU07/000695 (Pub. No. WO2007/134389) entered in the US on Nov. 18, 2008, the entire disclosures of each of which of the above publications shall be deemed to be incorporated by reference herein.

### AREA OF THE INVENTION

This invention relates to a nozzle which contains inserts and particularly to a spray nozzle for use in applications where extreme temperatures are met by the nozzle or where fragile components must be retained without damage.

### BACKGROUND TO THE INVENTION

Nozzles of the type to which this specification will refer are a commodity item used in very large numbers and can be threaded directly into pipe, or to attachments to which pipes are connected to provide a spray and in a conventional application there can be a substantial number of these nozzles along a particular length of pipe-work.

The nozzles themselves can vary from nozzles which are very small, having an overall body diameter of the order of 1 centimetre up to nozzles which are substantially larger than this.

In practice the nozzles may be turned from a metallic rod, normally brass but possibly stainless steel, or are cast and later milled. In order to ensure good distribution and spray pattern from the nozzle it is quite usual that the line end of the nozzle is counter-bored and receives an insert which can, for example, impart a rotatory motion to the fluid as it passes into the nozzle and a variety of other types of patterns such as solid jet, needle jet or flat fan.

These inserts may be cast or machined and are normally a frictional fit within the nozzles. Such nozzles are quite satisfactory in general use. However, there are situations where the conventional nozzles are less than satisfactory and one of these is where the nozzles are used to spray very hot materials. In one such application the nozzles may be used to spray a liquid onto a metal rod or sheet before rolling where the metal is “red hot”.

For the liquid to reach the surface of the metal it is necessary that the nozzles be located very close to the surface and in practice it has been found that the expansion of the nozzle tends to be differential so that the inserts are no longer held within the nozzles but are in effect basically free floating.

If there then happens to be any form of reverse pressure, either because of a fluctuation in the fluid line pressure or possibly even through evaporation of liquid in the nozzles, or should there be any physical movement as by vibration or hammer in the pipes, then the insert can leave the nozzle and pass into the line.

If this occurs then there can be a partial blockage of the line or of a particular other nozzle, if the insert stops in the line, and in order to correct this the spraying operation has to be stopped, the insert has to found and removed and, of course, the faulty nozzle has to be replaced. Where the system is being used in a time critical situation, such as with a steel rolling mill, this can be extremely expensive as the line may have to be stopped for repair.

It has been known to provide a retaining means for an insert in a nozzle by at least partially peening over the end of the counter-bore to prevent movement of the insert.

In that particular type of nozzle the lip of the end of the counter-bore is shaped during manufacture to be tapering towards the end of the lip and a die or the like is used to form the lip so as to retain the insert whilst at the same time ideally providing no specific intrusion which could adversely affect fluid flow in the line. In practice however it has been found that the crimping does cause some degree of turbulence in the flow into the back of the nozzle.

A further problem with the inserts as retained in this manner is that they are subject to high pressure leakage. In addition they can be damaged during the crimping process, this is particularly so for Ruby or ceramic inserts as used in high pressure washing, trimming and cutting applications of the type typically found in paper mills and other such industries.

An additional problem that relates to ruby and ceramic inserts is that in brush showers, and the like, where the internal longitudinal rotating brush cleans the nozzle nipple that protrudes into the pipe, damage can be caused to the inserts. This is because such edges are more fragile in shear and can be chipped or damaged by the brush bristles.

### OUTLINE OF THE INVENTION

It is an object of the invention to provide a brush shower nozzle assembly having a hard-wearing insert and an insert shield to protect the insert, but permitting access of brush shower bristles proximal to the insert aperture without damaging it for cleaning of the nozzle. Advantageously, the invention comprises a means is provided for protecting that part of the insert, where it is ruby or ceramic, from damage by cleaning brush bristles.

In one aspect, the invention provides a brush shower spray nozzle assembly comprising:
(a) a metallic spray nozzle having a nozzle body for fixment in a bore of a brush shower, a nozzle orifice, and a counterbore for retaining an insert;
(b) the insert for controlling—spray through said nozzle orifice in said brush shower, said insert having a central aperture;
(c) an insert shield having a central shield aperture coaxial with the central insert aperture and tapered in thickness from its periphery toward said central shield aperture. This allows brush access to the area proximal to the central insert aperture.

Preferably, the insert and the insert shield are retained in the counterbore by a retaining lip which is formed by deformation of the outer periphery of the counterbore. The retaining lip may be formed by deformation or peening of an outer periphery of the counterbore. This may initially be toward an axis of the metallic spray nozzle and, subsequently, outwardly.

A threaded portion may be formed on an outer surface of the metallic spray nozzle. At an outer inlet end, the nozzle body may include a tapered portion of said threaded portion. The tapered portion may be capable of being peened or deformed toward an axis of the counterbore for providing said retaining lip. The nozzle body is preferably threadably secured to a brush shower by the threaded portion.

The retaining lip preferably acts as a barrier for preventing the insert or the insert shield from exiting the metallic spray nozzle.

The insert shield preferably has an annular shape. It preferably radially tapers inwardly from a periphery of the insert shield toward the central shield aperture.

The metallic spray nozzle preferably protrudes a small distance into the brush shower pipe for exposure to rotatable cleaning brush bristles.

The shield preferably tapers to a substantially narrow annular edge defining the central shield aperture. The shield may have a cross-sectional profile whereby an upstream surface of the shield is inclined at an angle of about 20° to a plane normal to the nozzle axis and terminates to define the central aperture. The central aperture may be defined by a narrow annual edge that in axial length about 10-15% smaller in the axial dimension than the outer periphery of the shield. The shield preferably defines a shallow frusto-conical cavity giving protection to the insert whilst also providing cleaning access to the central aperture.

In another aspect, the invention provides a method of forming a spray nozzle assembly, comprising the steps of
(a) forming a metallic spray nozzle having a nozzle body and a counterbore at an inlet end of the nozzle body and an outlet orifice at an outlet end opposed to the inlet end;
(b) providing an insert for controlling spray through the outlet orifice, the insert having a central aperture; and
(c) covering the insert with a protective shield that is retained in the counterbore between the insert and the inlet end.

The method may further comprise the step of fixing the nozzle body in a bore of a brush shower. Alternatively or in addition, the method may further comprise the step of crimping an outer edge of the inlet end to form a retaining lip that retains the protective shield and the insert in the counterbore.

The method may further comprise the step of providing an O-ring in an annular groove axially facing a downstream inner face of the insert that cushions the insert during the crimping process.

The insert shield preferably has an annular shape with a central aperture and extends in a tapering fashion from within the outer periphery of the nozzle towards the aperture.

The nozzle preferably is sealed so as to prevent high pressure leakage without the use of glues and the like. The spray nozzle preferably has sealing means between a locating shoulder in the nozzle body and the inner face of the insert.

The insert shield preferably has an annular shape. The nozzle preferably comprises a metallic spray nozzle having a counterbore from one side thereof into which a ruby or ceramic or other such insert is located and retained by means of deformation of the outer periphery of the counterbore towards an axis of the nozzle having an O ring or other sealing membrane between a locating shoulder in the nozzle body and the inside edge of the insert. The sealing means is preferably an O ring. Preferably the insert shield is a shield for a ruby insert.

The invention in another aspect is a metallic spray nozzle having a counterbore from one side thereof into which an insert to control the spray is located and retained by means of deformation of the outer periphery of the counterbore. This deformation can in one embodiment of the invention be towards an axis of the nozzle.

In a further embodiment of the invention this deformation can be firstly towards an axis of the nozzle and subsequently outwards at its extremity such that flow into the counterbore is smooth.

In order that the invention may be more readily understood we shall describe by way of non limiting example embodiments of the nozzle made in accordance with the invention as shown in the drawing figures.

### BRIEF DESCRIPTION OF THE DRAWING FIGURES

FIG. 1 is a cross-sectional view of the nozzle after peening;

FIG. 2 is a schematic view of the formation of an inwardly directed crimp;

FIG. 3 is a schematic view of the formation of a retaining lip having an outwardly directed upper edge;

FIG. 4 is a perspective view of an insert shield;

FIG. 5 is a diagrammatic cross-section through an assembled nozzle with sealing means, insert, insert shield and retaining lip; and

FIG. 6 is a diagrammatic cross-section through the nozzle shown in FIG. 5 showing direction of flow.

### DESCRIPTION OF EMBODIMENTS OF THE INVENTION

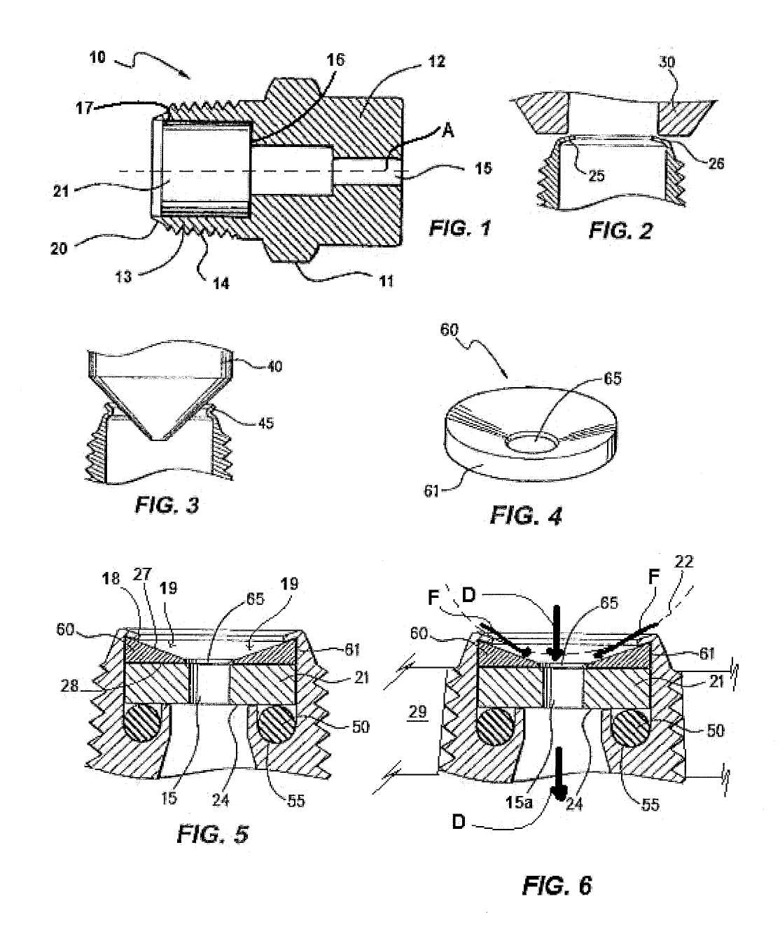

The nozzle of the invention 10 can basically be considered conventional and is shown in FIG. 1. It can be either machined from a metallic rod or cast and machined. The nozzle 10 is generally cylindrical, having part way along its outer length lands 11 or the like which provide a hexagonal shape to permit the nozzle to be rotated by a spanner or the like.

At an outlet end 12 the nozzle 10 has an aperture 15 that forms the actual orifice of the nozzle 10 while the opposed inlet end 13 has formed therein a counter-bore 16 thereinto and has a threaded portion 14 on its outer surface. As the skilled person will be familiar, the outer surface of the threaded portion 14 engages with a complementary threaded bore in a brush shower pipe 29 as shown in FIG. 6.

The nozzle 10 has a tapered portion 20 at the outer end of the inlet end 13 and the threaded portion 14, which can be peened or otherwise deformed towards a counterbore axis A. This tapered portion 20 can be formed after the threaded portion 14 has been cut and, possibly, in the same operation as the threaded portion 14 cutting operation. The tapered portion 20 includes an inner part 25 and an outer edge 26 forming an outer edge of the nozzle 10 at the inlet end 13.

The nozzle 10 is assembled by locating an insert 21 in the counterbore 16. An outer edge of the insert 21 terminates adjacent the inner part 25 of the tapered portion 20. An annular die 30 in a press can then be moved down over the tapered portion 20 and cause an inward deformation or crimping of the outer edge 26 of the nozzle 10 which provides a retaining lip 18 which acts as a barrier to prevent the insert 21 from escaping from the nozzle 10 during use. A flaring tool 40 can then be inserted into the counterbore 16 to deform the outermost edge 26 outwards to create a flared crimp 45 as shown in FIG. 3 so that the fluid entering the nozzle 10 passes a smooth curved edge when it passes the retaining lip 18 as illustrated by flow paths F in FIG. 6. This smooth flow path F does not contribute to turbulence of the fluid in an area 19 defined by an upper frusto-conical surface 27 of a shield 60 as it enters a central aperture 65 of the insert 21. As illustrated in FIG. 6, fluid is shown to enter the inlet end 13 and to flow from top to bottom in FIGS. 5 and 6 and out through the aperture 15 in a flow direction D as shown in FIG. 6.

Where the insert 21 is a ceramic, ruby or other such insert having a central aperture 15a, these inserts also are retained by the procedure creating a rolled lip 18 as described earlier.

A very good seal at an inner face 24 of the insert is required to be achieved as high pressures are involved, for example in the brush showers used in the paper mill industry, and there is a greater opportunity for liquid streams to find a passage between the insert 21 and the nozzle body and to intersect the primary liquid jet emitted, as the skilled person will appreciate, from the nozzle orifice 15 thereby severely disturbing it. In order to provide such a seal, as shown in FIG. 5, an O-ring 50 or other sealing membrane is located between a shoulder 55 in the nozzle 10 body and the inner face 24 of the insert 21. While this provides an effective seal, there is also the advantage that the crimping pressure on the retaining lip 18 that is required to create a seal is reduced as the compression on the resiliently deformable rubber O-ring 50 enhances the seal.

A further advantage of this seal arrangement is that the insert 21, which is typically made of hard-wearing but fracturable material, is cushioned by the O-ring 50 during the crimping process and is therefore less likely to be damaged.

As previously stated, however, ruby and ceramic inserts 21 are vulnerable to damage caused by the bristles of cleaning brushes used in brush shower pipes to clean the inlet end 13 of the nozzle 10. As stated above, the insert 21 made from ruby or ceramic material used in the nozzle assemblies for brush shower pipes, can be damaged by the normal cleaning action of an internal longitudinal rotating brush that is designed to clean the nozzle nipple that protrudes into the brush shower pipe. The nozzle nipple protrudes a small distance into the brush shower pipe 29 for exposure to the cleaning brush bristles 22 and damage can be caused to the insert 21. This is because the ruby and ceramic insert 21 edges are more fragile in shear and can be chipped or damaged by the brush bristles 22.

This problem is addressed in the invention by providing the insert shield 60 as shown in FIG. 4 which generally covers the ruby or ceramic surface 27 of the insert 21 and is located within the peened periphery of the tapered portion 20.

This insert shield 60 is a circular component with a central aperture 65 which is located inside the peened periphery of the nozzle 10 and tapers in thickness from its periphery 61 towards its central aperture 65 and the upstream end of the insert aperture 15a. This tapering effect further stabilizes the spray emitted by at the outlet end 12 by allowing liquid not entering the nozzle orifice 15 to smoothly exit the area 19 by following the taper defined by the frusto-conical surface 27 out rather than exiting across an upper insert face 28, hitting the crimped retaining lip 18 and causing turbulence.

The profile of the central shield aperture 65 is, as shown in FIG. 5, extremely thin, preferably paper thin, as the frusto-conical surface 27 and lower surface facing upper insert surface 28 radially inwardly converge to taper to a substantially narrow annular inner edge defining the central shield aperture 65.

In the cross-sectional profile shown in FIGS. 5 and 6, the upstream frusto-conical surface 27 of the shield 60 is inclined at an angle of about 20° to a plane normal to the nozzle 10 axis A and terminates at its inner extent to define the central aperture 65 with a narrow annual edge. The narrow annual edge defining the central aperture 65 is in axial length about 10-15% smaller in the axial dimension than the outer periphery 61 of the shield 60.

The sweep or area covered by the rotating brush is schematically represented in FIG. 6 by reference numeral 22. This shows that the bristles 22 penetrate into the counterbore 16 and into the area 19 and proximal to the central insert aperture 15a to clear any debris collecting in the area 19.

The shield 60 defines the area 19 as a shallow frusto-conical cavity that provides protection to the hard-wearing but fragile insert 21 whilst also enabling cleaning access of shower brush bristles 22 close to the central aperture 65 and the insert aperture 15a, that would otherwise be prone to clogging.

By the means described above significant improvements are provided in prior rolled lip insert retaining type nozzles and whilst we have described herein specific embodiments of the invention it is envisaged that other embodiments of the invention will exhibit any number of and any combination of the features previously described and it is to be understood that variations and modifications in this can be made without departing from the spirit and scope of the invention.

1. A brush shower spray nozzle assembly-comprising:
(a) a metallic spray nozzle having a nozzle body for fixment in a bore of a brush shower, a nozzle orifice, and a counterbore for retaining an insert;
(b) the insert for controlling—spray through said nozzle orifice in said brush shower, said insert having a central aperture;
(c) an insert shield having a central shield aperture coaxial with the central insert aperture and tapered in thickness from its periphery toward said central shield aperture.

2. A spray nozzle assembly as claimed in claim 1, wherein said insert and said insert shield are retained in said counterbore by a retaining lip which is formed by deformation of the outer periphery of the counterbore.

3. A spray nozzle assembly as claimed in claim 1, having sealing means between a locating shoulder in the nozzle body and the inner face of the insert.

4. A spray nozzle assembly as claimed in claim, wherein the insert shield has an annular shape.

5. A spray nozzle assembly as claimed in claim 1, wherein the insert shield is a ruby insert shield.

6. The spray nozzle assembly accordingly to claim 2, wherein said retaining lip is formed by deformation or peening of an outer periphery of the counterbore, initially toward an axis of said metallic spray nozzle and, subsequently, outwardly.

7. The spray nozzle assembly according to claim 2, wherein a threaded portion formed on an outer surface of said metallic spray nozzle includes a tapered portion at an outer end of said threaded portion capable of being peened or deformed toward an axis of the counterbore for providing said retaining lip.

8. The spray nozzle assembly according to claim 7, wherein said retaining lip acts as a barrier for preventing said insert or said insert shield from exiting said metallic spray nozzle.

9. The spray nozzle assembly according to claim 1, wherein said nozzle body is threadably secured to said brush shower.

10. The spray nozzle assembly according to claim 1, wherein the insert shield has an annular shape and radially tapers inwardly from a periphery of said insert shield toward said central shield aperture.

11. A spray nozzle assembly as claimed in claim 3, in which the sealing means is an O ring.

12. The spray nozzle assembly according to claim 1, wherein the metallic spray nozzle protrudes a small distance into the brush shower pipe for exposure to rotatable cleaning brush bristles.

13. The spray nozzle assembly according to claim 1, wherein the shield tapers to a substantially narrow annular edge defining the central shield aperture.

14. The spray nozzle assembly according to claim 1, wherein the shield has a cross-sectional profile whereby an upstream surface of the shield is inclined at an angle of about 20° to a plane normal to the nozzle axis and terminates to define the central aperture.

15. The spray nozzle assembly according to claim 1, wherein the central aperture is defined by a narrow annual edge that in axial length about 10-15% smaller in the axial dimension than the outer periphery of the shield.

16. The spray nozzle assembly according to claim 1, wherein the shield defines a shallow frusto-conical cavity giving protection to the insert whilst also providing cleaning access to the central aperture.

17. A method of forming a spray nozzle assembly, comprising the steps of:
(a) forming a metallic spray nozzle having a nozzle body and a counterbore at an inlet end of the nozzle body and an outlet orifice at an outlet end opposed to the inlet end;
(b) providing an insert for controlling spray through the outlet orifice, the insert having a central aperture;
(c) covering the insert with a protective shield that is retained in the counterbore between the insert and the inlet end;

18. The method according to claim 17, further comprising the step of:
(d) fixing the nozzle body in a bore of a brush shower.

19. The method according to claim 17, further comprising the step of:
(d) crimping an outer edge of the inlet end to form a retaining lip that retains the protective shield and the insert in the counterbore.

20. The method according to claim 19, further comprising the step of:
(e) providing an O-ring in an annular groove axially facing a downstream inner face of the insert that cushions the insert during the crimping process.
